(19) United States
(12) Patent Application Publication
(10) Pub. No.: US 2019/0254326 A1
(43) Pub. Date: Aug. 22, 2019

(54) POWDERED CANNABIS PRODUCTS, PRODUCTS CONTAINING POWDERED CANNABIS, AND PROCESSES OF MAKING SAME

(71) Applicant: XANTHIC BIOPHARMA INC., Toronto (CA)

(72) Inventors: Derrick WELSH, Toronto (CA); Igor GALITSKY, Toronto (CA)

(73) Assignee: XANTHIC BIOPHARMA INC., Toronto (CA)

(21) Appl. No.: 16/275,731

(22) Filed: Feb. 14, 2019

(30) Foreign Application Priority Data
Feb. 16, 2018 (CA) 2995501

(51) Int. Cl. A23L 33/105; A23L 5/30; A23L 29/30; A23P 10/40

(52) U.S. Cl. CPC A23L 33/105; A23L 5/32; A23V 2002/00; A23P 10/40; A23L 29/35

(57) ABSTRACT

A process of producing an edible powder containing cannabis including providing a desired quantity of cannabis oil, a cannabis isolate or a cannabis distillate, mixing the cannabis oil, cannabis isolate or cannabis distillate with a solvent and forming an emulsion, providing a starch powder, mixing the emulsion with the starch powder to form a mixture, and removing the solvent from the mixture.

### CROSS-REFERENCES TO RELATED APPLICATIONS

This application claims the benefit of Canadian Patent Application No. 2,995,501 filed Feb. 16, 2018 and titled, “Powdered Cannabis Products, Products Containing Powdered Cannabis, and Processes of Making Same”. The entire contents of all related applications are incorporated by reference herein.

### FIELD

The present disclosure relates generally to powdered cannabis products, products containing powdered cannabis, and processes of making same.

### BACKGROUND

Cannabis can be consumed by humans in a number of ways. Some people prefer to consume edible cannabis products, such as drinks containing cannabis oil. Cannabis oil, however, is not naturally soluble in water, and attempts have been made at producing powered cannabis oil products that can be used in a drink. In certain jurisdictions, the amount of cannabinoids in edible cannabis products is regulated. In Canada for example, products meant for ingestion have a limit of 10 mg of the cannabinoid tetrahydrocannabinol (“THC”) per dose. Producing powdered cannabis products with a consistent distribution of THC and/or one or more other cannabinoids that meet local regulations has proved challenging.

### SUMMARY

In one aspect, the present disclosure relates to a process of producing an edible powder containing cannabis including providing a desired quantity of a cannabis oil, mixing the cannabis oil with a solvent to form an emulsion, providing a desired amount of a starch powder, mixing the emulsion with the starch powder to form a mixture, and removing the solvent from the mixture. In one aspect, a paste is formed with the mixture. In one aspect, the solvent is ethanol. In one aspect, the starch powder is a maltodextrin powder. In one aspect, the starch powder includes a maltodextrin powder and a tapioca powder. In one aspect, the process further includes heating the mixture under vacuum conditions to remove the solvent or substantially all of the solvent from the paste. In another aspect, the process further includes breaking up the mixture into a powder following removal of the solvent. In another aspect, the process further includes subjecting the emulsion to sonification. In another aspect, the process further includes remixing the mixture and repeating the step of heating the mixture under a vacuum to remove ethanol from the mixture. In another aspect, the present disclosure relates to a product made according to the processes described above.

In another aspect, the present disclosure relates to a powdered cannabis product including a cannabis oil and a maltodextrin powder, such that the ratio of cannabis oil to the maltodextrin powder is in the range of 1:100 to 1:10. In another embodiment, the powered cannabis product further includes a tapioca starch powder. In one embodiment, the ratio of the maltodextrin powder to the tapioca powder is 3:1. In one embodiment, the ratio of cannabis oil to the combined maltodextrin powder and the tapioca powder is in the range of 1:100 to 1:10.

In another aspect, the present disclosure relates a powdered cannabis product including a cannabis isolate and a maltodextrin powder, such that the ratio of cannabis isolate to the maltodextrin powder is in the range of 1:100 to 1:10. In another embodiment, the powered cannabis product further includes a tapioca starch powder. In one embodiment, the ratio of the maltodextrin powder to the tapioca powder is 3:1. In one embodiment, the ratio of cannabis isolate to the combined maltodextrin powder and the tapioca powder is in the range of 1:100 to 1:10.

In another aspect, the present disclosure relates to a process of producing an edible powder containing cannabis isolate including providing a desired quantity of a cannabis isolate, mixing the cannabis isolate with a solvent to form an emulsion, providing a desired quality of a starch powder, mixing the emulsion and the starch powder to form a mixture, and removing the solvent from the mixture. In one aspect, the mixture is a paste. In one aspect, the solvent is ethanol. In one aspect, the starch is maltodextrin powder. In one aspect, the starch includes a maltodextrin powder and a tapioca powder. In one aspect, the process further includes heating the mixture and applying a vacuum to the mixture to remove solvent from the paste. In another aspect, the process further includes breaking the paste into a powder following removal of the solvent. In another aspect, the process further includes subjecting the emulsion to sonification. In another aspect, the process further includes remixing the mixture and repeating the step of heating the mixture in a vacuum to remove ethanol from the mixture. In another aspect, the present disclosure relates to a product made according to the processes disclosed in the present disclosure.

### BRIEF DESCRIPTIONS OF DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a flowchart of an embodiment of the process for producing a powdered cannabis oil product; and

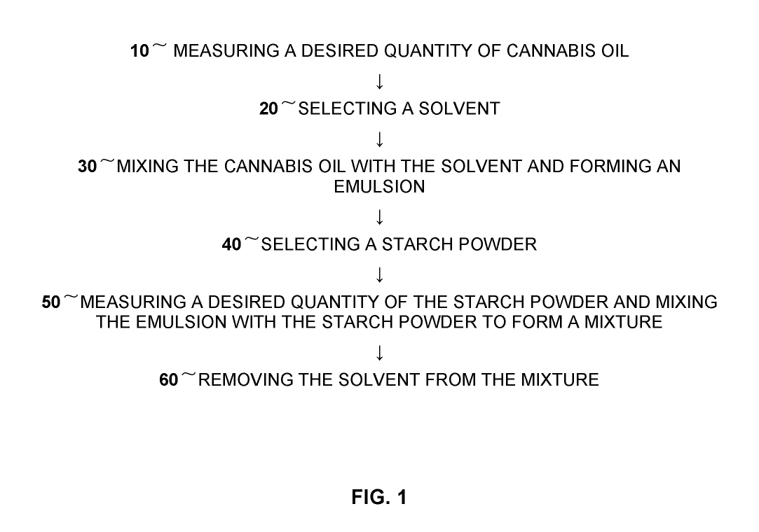

FIG. 2 is a is a flowchart of another embodiment of the process for producing a powdered cannabis isolate or distillate product.

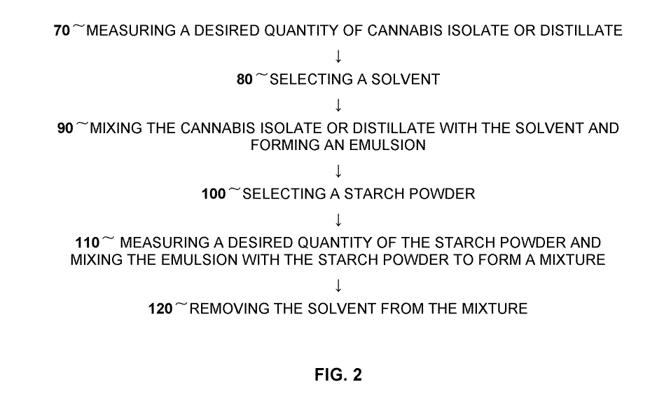

### DETAILED DESCRIPTION

In one embodiment, the present invention relates to a process of producing an edible powder containing cannabis. A desired quantity of a cannabis oil extract is measured 10 and a solvent selected 20 and the cannabis oil is mixed with a solvent to form an emulsion 30. In one embodiment, the solvent is ethanol. In certain other embodiments, the solvent is selected from the group consisting of ethanol, isopropanol, chloroform, methane, hexane, cyclohexane, acetone, pentane and combinations thereof. Local food contact regulations and/or fire codes may govern which solvent(s) are permitted. In one embodiment, the cannabis oil and the solvent is heated while forming the emulsion. Heating promotes fluidization of the mixture. In one embodiment, the emulsion is made in a beaker and stirred while being heated to a temperature of about 79° C. for approximately 25-30 minutes. Mixing times may vary but in one embodiment, the emulsion is mixed until there is no significant phase separation in the emulsion. Forming an emulsion promotes the even distribution of cannabinoids throughout the emulsion. Heating of the emulsion also promotes decarboxylation provided that the emulsion is heated to suitable temperatures because the two main catalysts for decarboxylation are heat and time. In one embodiment, heating of the emulsion to a temperature in the range of about 240° F. to 243° F. promotes decarboxylation. Temperatures above about 243° F. denature the cannabinoid(s) in cannabis oil. In another embodiment, where decarboxylation is not required because the cannabis oil has previously been decarboxylated, the emulsion is heated to about 80° C. In another embodiment, the emulsion is subjected to sonication to further break down cannabis oil droplets in the emulsion into nanoparticles and/or microparticles. Reducing the size of the cannabis oil droplets increases the bioavailability of the cannabinoids in the cannabis oil. Smaller cannabis oil droplets also improve the resulting powdered product by promoting more uniform distribution of the cannabinoids in the resulting powder. In one embodiment, sonication of the emulsion can be carried out with a cavitational homogenizer.

A starch powder is selected 40 and a desired quantify of the starch powder is measured and the cannabis oil emulsion is mixed with the starch powder 50. In one embodiment, the starch is a maltodextrin powder. In another embodiment, the starch is a mixture of a maltodextrin powder and a tapioca powder. In one embodiment, the starch powder is a mixture of a maltodextrin powder and a tapioca powder in a ratio of about 3:1. In one embodiment, the emulsion and the starch powder are mixed to form a paste. In one embodiment, the proportion of cannabis oil to starch powder is 10 mg cannabis oil to 1 g starch powder. In other embodiments, the proportion of cannabis oil to starch powder ranges from 20 to 100 mg of cannabis oil to 1 g of starch powder. In other embodiments, the ratio of cannabis oil to starch powder ranges from 1:100 to 1:10.

In a next step, the solvent or substantially all of the solvent is removed from the mixture 60. In one embodiment, where a paste has been formed from the mixture, the paste is flattened on a pan and placed in a vacuum purge oven. In one embodiment, the oven temperature used is about 230° C. In another embodiment, the oven temperature is about 120° C. when a vacuum purge is not used. Care should be taken not to heat the paste to a temperature where a substantial amount of the cannabinoids in the paste are “boiled off”. In one embodiment, the paste is purged for about 24 hours. In another embodiment, the paste is purged until substantially all of the solvent has been removed from the paste. In another embodiment, after purging, the paste is re-blended, flattened again and placed again in the vacuum purge oven for a second purge session. In one embodiment, the second purge session is about 12 hours in duration.

In another embodiment, the present invention relates to a process of producing an edible powder containing cannabis. A desired quantity of a cannabis isolate or distillate is measured 70, a solvent is selected 80, and the cannabis isolate or distillate and the solvent are mixed and emulsified 90. In certain embodiments, the cannabinoid isolate may be selected from the group consisting of:

BGA (Cannabigerolic acid)

THCA (Δ9-tetrahydrocannabinolic acid)

CBDA (Cannabidiolic acid)

CBCA (Cannabichromenenic acid)

CBGVA (Cannabigerovarinic acid)

THCVA (Tetrahydrocanabivarinic acid)

CBDVA (Cannabidivarinic acid)

CBCVA (Cannabichromevarinic acid)

CBG (Cannabigerol)

THC (Δ9-tetrahydrocannabinol)

CBD (Cannabidiol)

CBC (Cannabichromene)

CBGV (Cannabigerivarin)

TH CV (Tetrahydrocannabivarin)

CBDV (Cannabidivarin)

CBCV (Cannabichromevarin)

and combinations thereof.

In one embodiment, the solvent is ethanol. In certain other embodiments, the solvent is selected from the group consisting of ethanol, chloroform, methane, hexane, cyclohexane, acetone, pentane and combinations thereof. Heating promotes fluidization of the mixture. In one embodiment, the mixture is made in a beaker and stirred while heated to a temperature of about 79° C. for approximately 25-30 minutes. Mixing times may vary but preferably, mixing should continue until there is no significant phase separation in the mixture. The emulsion also promotes the even distribution of the isolate throughout the emulsion. Heating of the emulsion also promotes decarboxylation provided that the emulsion is heated to suitable temperatures because the two main catalysts for decarboxylation are heat and time. In one embodiment, heating the emulsion to a temperature of in the range of about 240° F. to 243° F. promotes decarboxylation. Temperatures above about 243° F. denature the isolate.

In another embodiment, the emulsion is heated to about 80° C. where decarboxylation is not required because the isolate has previously been decarboxylated. In another embodiment, the mixture is subjected to sonication to break down isolate droplets in the mixture into nanoparticles and/or microparticles. Reducing the size of the isolate droplets increases the bioavailability of the cannabinoids in the isolate. Smaller isolate droplets also improves the resulting powdered product by promoting more uniform distribution of the cannabinoids in the resulting powder. In one embodiment, sonication can be carried out with a cavitational homogenizer.

A starch powder is selected 100 and a desired quantity of starch powder is measured and mixed with the emulsion to form a mixture 110. In one embodiment, the starch is a maltodextrin powder. In another embodiment, the starch is a mixture of a maltodextrin powder and a tapioca powder. In one embodiment, the starch powder is a mixture of a maltodextrin powder and a tapioca powder in a ratio of about 3:1. In one embodiment, the emulsion and the starch powder are mixed to form a paste. In one embodiment, the proportion of cannabis oil to starch powder is 10 mg cannabis oil to 1 g starch powder. In other embodiments, the proportion of cannabis oil to starch powder ranges from 20 to 100 mg of cannabis oil to 1 g of starch powder. In other embodiments, the ratio of cannabis oil to starch powder ranges from 1:100 to 1:10.

In a next step, the solvent is removed from the mixture 120. In one embodiment, the paste is flattened on a pan and placed in a vacuum purge oven. In one embodiment, the oven temperature is about 230° C. In another embodiment, the oven temperature is about 120° C. when a vacuum purge is not used. The paste should not be heated too much such that cannabinoids in the paste are “boiled off”. In one embodiment, the paste is purged for about 24 hours. In another embodiment, the paste is purged until substantially all of the solvent has been removed from the paste. In another embodiment, after purging, the paste is re-blended, flattened again and placed again in the vacuum purge oven for a second purge session. In one embodiment, the second purge session is about 12 hours in duration.

According to certain embodiments of the processes of the present invention, following removal of the solvent, the resulting paste is chalk-like in consistency and can be processed into a powder. Powderization can be achieved through mechanical means such as pulverization or milling using for example a blender or grinder.

Powdered products made according to embodiments of processes of the present invention can be added to a variety of edible products. For example, the powdered product can be used in drinks such as fruit drinks, rescue drinks and energy drinks. The powdered product can also be added to a wide variety of foods such as for example cake mixes, soups, chocolate, dips and toppings.

We claim:

1. A process of producing an edible powder containing cannabis comprising:
providing a desired quantity of one of a cannabis oil, a cannabis isolate and a cannabis distillate,
mixing the one of a cannabis oil, a cannabis isolate and a cannabis distillate with a solvent to form an emulsion,
providing a desired quality of a starch powder,
mixing the emulsion and the starch powder to form a mixture, and
removing the solvent from the mixture.

2. The process of claim 1, further including forming a paste with the mixture.

3. The process of claim 2, wherein the solvent is ethanol.

4. The process of claim 3, wherein the starch powder is maltodextrin.

5. The process of claim 3, wherein the starch powder comprises maltodextrin and tapioca.

6. The process of claim 1, further comprising heating the mixture in a vacuum to remove solvent from the paste.

7. The process of claim 1, wherein the solvent is selected from the group consisting of ethanol, isopropyl alcohol, chloroform, methane, hexane, cyclohexane, acetone, pentane and mixtures thereof.

8. The process of claim 6, following removal of the solvent, further comprising breaking the paste into a powder.

9. The process of claim 1, further comprising subjecting the emulsion to sonification.

10. The process of claim 6, further comprising remixing the paste and repeating the step of heating the paste in a vacuum to further remove the solvent from the paste.

11. The process of claim 4, wherein the ratio of the one of a cannabis oil, a cannabis isolate and a cannabis distillate to the starch powder is 10 mg cannabis oil to every 1 g of the starch powder.

12. The process of claim 4, wherein in the ratio of the one of a cannabis oil, a cannabis isolate and a cannabis distillate to the starch powder, the quantity of the cannabis oil is selected from the group consisting of 20 mg, 30 mg, 40 mg, 50 mg, 60 mg, 70 mg, 80 mg, 90 mg and 100 mg of cannabis oil.

13. The process of claim 4, wherein the ratio of the one of a cannabis oil, a cannabis isolate and a cannabis distillate to the starch powder is in the range of 1:100 to 1:10.

14. The process of claim 1, wherein the step of heating the paste under vacuum is carried out for a period of about 24 hours.

15. The process of claim 4, wherein the paste is heated to a temperature of about 240° F. to 243° F.

16. The process of claim 15, wherein the step of heating the paste is carried out until substantially all of the solvent is removed from the paste.

17. The process of claim 14, further comprising the step of forming the paste into a flattened layer for heating.

18. The process of claim 17, wherein the layer is about ¼ inch in thickness.

19. A powdered cannabis oil product comprising: one of a cannabis oil, a cannabis isolate and a cannabis distillate; a maltodextrin powder, and a tapioca powder, wherein the one of a cannabis oil, a cannabis isolate and a cannabis distillate has been absorbed by the maltodextrin and tapioca powder, such that the ratio of one of a cannabis oil, a cannabis isolate and a cannabis distillate to the combined amount of maltodextrin powder, and tapioca powder is in the range of 1:100 to 1:10.

20. A powdered cannabis product made according to the process of claim 1.

21. The process of claim 1, wherein the cannabis isolate or distillate is selected from the group consisting of BGA (Cannabigerolic acid), THCA (Δ9-tetrahydrocannabinolic acid), CBDA (Cannabidiolic acid), CBCA (Cannabichromenenic acid), CBGVA (Cannabigerovarinic acid), THCVA (Tetrahydrocanabivarinic acid), CBDVA (Cannabidivarinic acid), CBCVA (Cannabichromevarinic acid), CBG (Cannabigerol), THC (Δ9-tetrahydrocannabinol), CBD (Cannabidiol), CBC (Cannabichromene), CBGV (Cannabigerivarin), THCV (Tetrahydrocannabivarin), CBDV (Cannabidivarin), CBCV (Cannabichromevarin), and combinations thereof.
